(19) United States
(12) Patent Application Publication
(10) Pub. No.: US 2025/0175108 A1
(43) Pub. Date: May 29, 2025

(54) MOTOR CONTROL DEVICE AND MOTOR CONTROL METHOD

(71) Applicant: HL MANDO CORPORATION, Gyeonggi-do (KR)

(72) Inventor: Jaesang PARK, Gyeonggi-do (KR)

(21) Appl. No.: 18/957,660

(22) Filed: Nov. 23, 2024

(30) Foreign Application Priority Data
Nov. 24, 2023 (KR) 10-2023-0165262

(51) Int. Cl. H02P 25/028; H02P 6/28; H02P 29/64

(52) U.S. Cl. CPC H02P 25/028; H02P 6/28; H02P 29/64; H02P 2205/05; H02P 2207/05

(57) ABSTRACT

Disclosed herein are a motor control device and a motor control method. The motor control method receiving a torque command to control a motor and generating a reference current includes calculating maximum torque of the motor based on the torque command, determining whether the calculated maximum torque exceeds a torque limit, and calculating maximum torque per unit current, when the calculated maximum torque does not exceed the torque limit.

### CROSS REFERENCE TO RELATED APPLICATION

The present application claims priority to Korean Patent Application No. 10-2023-0165262, filed on Nov. 24, 2023, the entire contents of which is incorporated herein for all purposes by this reference.

### TECHNICAL FIELD

The present disclosure relates to a motor control device and a motor control method, and more specifically, to a motor control device and a motor control method that allow a motor to operate at its maximum output torque.

### BACKGROUND

In general, a motor is controlled based on d-axis and q-axis currents flowing into a stator coil. Specifically, in the case of a permanent magnet synchronous motor, information for driving is transmitted to the motor through vector control.

However, conventionally, there is a problem in that a current for motor control is calculated using a value in which a motor parameter value for motor control is pre-stored, so that a current motor state is not reflected, resulting in an uncontrollable state or divergence of the motor.

In addition, there is a problem in that the motor should be operated at maximum torque to produce a required output but the torque is calculated based on a preset parameter value of the motor. Specifically, when the motor is operated in this way, the efficiency of the motor decreases.

Therefore, it is necessary to ensure that the motor is operated at maximum torque in consideration of a current state that varies depending on the current and temperature of the motor.

### SUMMARY

In view of the above, the present disclosure provides a motor control device and a motor control method that allow a motor to operate at its maximum output torque based on information reflecting a current motor state.

According to embodiments of the present disclosure, a motor control method receiving a torque command to control a motor and generating a reference current includes calculating maximum torque of the motor based on the torque command, determining whether the calculated maximum torque exceeds a torque limit, and calculating maximum torque per unit current, when the calculated maximum torque does not exceed the torque limit.

The calculating the maximum torque per unit current may perform calculation based on input reference torque and an estimated motor parameter.

The motor control method may further include calculating voltage using the calculated maximum torque per unit current, thereby determining whether the calculated voltage using the calculated maximum torque per unit current exceeds a voltage limit.

The motor control method may further include calculating constant torque or maximum torque per unit voltage, when the calculated voltage using the calculated maximum torque per unit current exceeds the voltage limit.

The calculating the constant torque or the maximum torque per unit voltage may include calculating the constant torque based on a motor speed and the estimated motor parameter, and determining whether to exceed the voltage limit on the calculated constant torque.

The calculating the constant torque or the maximum torque per unit voltage may further include calculating the maximum torque per unit voltage based on a current equation or a torque equation, when the voltage limit is exceeded.

The calculating the constant torque or the maximum torque per unit voltage may further include comparing the maximum torque per unit voltage calculated based on the current equation and the maximum torque per unit voltage calculated based on the torque equation, thereby setting larger torque as the maximum torque.

The motor control method may further include setting a reference current based on the set maximum torque.

The calculating the maximum torque per unit current may form a maximum torque region per unit current by finding a contact point where a current limit curve and a torque curve meet.

The calculating the constant torque may form a constant torque region by finding an intersection point where a voltage limit curve and the torque curve intersect.

The calculating the maximum torque per unit voltage may form a maximum torque region per unit voltage by finding an intersection point where the current limit curve and the voltage limit curve intersect.

The calculating the maximum torque per unit voltage may form a maximum torque region per unit voltage by finding a contact point where the voltage limit curve and the torque curve meet.

According to embodiments of the present disclosure, a motor control device for controlling a motor includes a final torque signal part outputting a torque command for operating the motor and reference torque, a parameter estimator transmitting estimated motor parameter information considering estimated wire temperature of the motor, and a motor reference calculator receiving information from the parameter estimator and the final torque signal part to output q-axis and d-axis reference currents.

A Newton-Raphson method and a Regula Falsi method may be stored in the motor reference calculator.

The motor reference calculator may use the stored Regula Falsi method when calculating the maximum torque per unit voltage.

The motor reference calculator may form a controllable current region including a region that forms the maximum torque per unit current, a region that maintains the constant torque, and a region that forms the maximum torque per unit voltage.

According to embodiments of the present disclosure, a motor control device and a motor control method allow a motor to operate at its maximum output torque based on information reflecting a current motor state, thereby improving the efficiency of the motor.

### BRIEF DESCRIPTION OF THE DRAWINGS

FIG. 1 illustrates a motor control device according to an embodiment of the present disclosure.

FIG. 2 illustrates a voltage curve according to an embodiment of the present disclosure.

FIG. 3 illustrates maximum torque per unit current according to an embodiment of the present disclosure.

FIG. 4 illustrates the calculation process of the Newton-Raphson method according to an embodiment of the present disclosure.

FIG. 5 illustrates constant torque according to an embodiment of the present disclosure.

FIGS. 6 and 7 illustrate maximum torque per unit voltage according to an embodiment of the present disclosure.

FIG. 8 illustrates a controllable current region according to an embodiment of the present disclosure.

FIGS. 9 and 10 illustrate the sequence of a motor control method according to an embodiment of the present disclosure.

### DETAILED DESCRIPTION

Embodiments of the present disclosure will be described in detail with reference to the accompanying drawings such that those skilled in the art can easily practice the present disclosure. However, the present disclosure may be implemented in various ways without being limited to particular embodiments described herein.

It is to be noted that the drawings are schematic and not drawn to scale. The relative dimensions and proportions of parts in the drawings may be exaggerated or reduced in size for clarity and convenience in the drawings, and any dimensions are merely illustrative but are not restrictive. The same reference numerals are used throughout the drawings to designate the same or similar components.

Embodiments of the present disclosure specifically represent ideal embodiments of the present disclosure. As a result, various variations of the drawings are expected. Therefore, the embodiments are not limited to the specific shape of the illustrated area and also cover changes in shape due to manufacturing, for example.

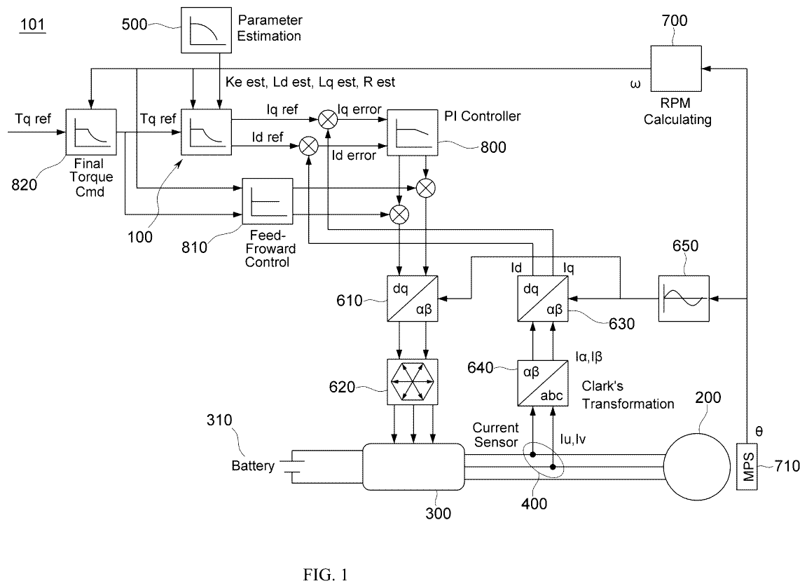

Hereinafter, a motor control device 101 according to an embodiment of the present disclosure will be described with reference to FIGS. 1 to 10.

As shown in FIG. 1, the motor control device 101 according to an embodiment of the present disclosure includes a final torque signal part 820, a parameter estimator 500, and a motor reference calculator 100 to calculate a motor 200.

The final torque signal part 820 outputs a torque command based on the angular velocity information of the motor 200 and input reference torque. Specifically, the final torque signal part 820 may receive angular velocity information calculated by an angular velocity calculator 700 using information detected by a motor location detector 710 that detects the rotation of the motor 200. The input to the final torque signal part 820 is an upper controller (system controller) or an external required torque command.

The parameter estimator 500 may provide a parameter value of the motor 200 considering the estimated wire temperature of the motor 200 based on a thermodynamic model of a coil that is preset according to the power consumption of the motor 200. Specifically, the parameter estimator 500 may provide a motor torque constant Ke_est, inductance Ld_est and Lq_est, and resistance R_est in which the current estimated wire temperature of the motor 200 is reflected.

That is, the estimated motor parameters provided by the parameter estimator 500 may be motor parameters that reflect changes depending on the temperature of the motor coil and changes depending on the current and temperature of the magnet by applying values that change in real time due to current and temperature.

The motor reference calculator 100 receives reference torque from the final torque signal part 820 and outputs q-axis and d-axis reference currents. Further, the motor reference calculator 100 may calculate and output the q-axis and d-axis reference currents corresponding to a command for controlling the motor 200 based on the reference torque.

Specifically, the command and reference torque for controlling the motor 200 are input from the final torque signal part 820. Further, the motor reference calculator 100 receives parameter information of the motor estimated from the parameter estimator 500. Further, the motor reference calculator 100 may receive the angular velocity information calculated by the angular velocity calculator 700.

Therefore, the motor control device 101 according to an embodiment of the present disclosure may calculate the reference current using the motor parameter that reflects changes depending on the temperature of the motor coil, so the motor 200 may be accurately controlled based on the value that changes in real time, instead of controlling the motor 200 based on the preset constant value.

Specifically, depending on the power consumption of the motor 200, the motor constant may be changed by the coil temperature. However, when the current is calculated based on only the set value without considering it, there is a problem in that an error occurs between the required command and the output value of the motor 200.

However, the motor control device 101 according to an embodiment of the present disclosure can calculate the reference current using the estimated motor parameter that changes in real time, thereby allowing the motor 200 to be more accurately controlled.

Further, the Newton-Raphson method and the Regula Falsi method may be pre-stored in the motor reference calculator 100 according to an embodiment of the present disclosure.

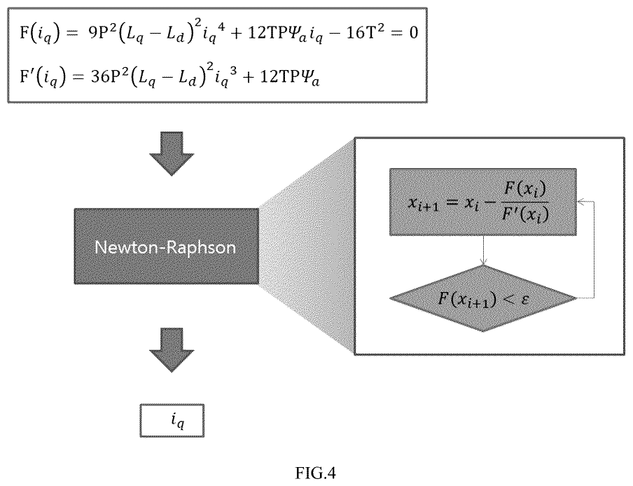

As shown in FIG. 4, the motor reference calculator 100 may calculate torque using the Newton-Raphson method and the Regula Falsi method, thereby effectively preventing the problem of taking a long time caused by an infinite number of repetitions for torque calculation.

At this time, ε may be a set error value.

Further, in the case of using the Regula Falsi method, the motor reference calculator 100 does not require differentiation, so it may be effectively applied when calculating functions that have domains that are impossible to differentiate or that are difficult to differentiate.

The motor control device 101 according to an embodiment of the present disclosure may further include an inverter 300 and a battery 310.

The inverter 300 converts DC into AC. Specifically, the inverter 300 outputs a three-phase signal to the motor 200.

The battery 310 supplies power to the inverter 300.

The motor control device 101 according to an embodiment of the present disclosure may further include a PI controller 800, the inverter 300, a feed-forward controller 810, a first transformation 610, a space vector modulation 620, a current detector 400, a second transformation 640, a third transformation 630, and a trigonometric function 650.

The PI controller 800 receives the q-axis current and d-axis current output by the motor reference calculator 100, and outputs voltage.

The feed-forward controller 810 may receive information required for the motor 200 to change an input value according to the current output state of the motor 200.

The first transformation 610 may receive voltage output from the PI controller 800, transform the voltage into a vector, and then output the vector. Specifically, the first transformation 610 may transform voltages Vd and Vq of the PI controller 800 into voltages Vα and Vβ.

As an example, the first transformation 610 may be an Inverse Park Transformation.

The space vector modulation 620 may generate a three-phase sinusoidal waveform for the windings of the motor 200 to control a pulse width for a switching device of the inverter 300. The space vector modulation 620 may output a plurality of control signals that adjust the rotational position or speed of the motor 200 based on the amplitude and angle of the voltage vector received from the first transformation 610.

That is, voltages Vα and Vβ output through the first transformation 610 may pass through the space vector modulation 620. Further, the voltage vector generated by the first transformation 610 may generate a pulse width modulation (PWM Duty) signal for controlling a switch of the inverter 300 through the space vector modulation 620. Such a signal may be a modulation voltage required to drive the motor 200 at a desired speed or torque.

The current detector 400 may detect the current that is output from the inverter 300 to the motor. Specifically, the current detector 400 detects currents Iu and Iv from an output end of the inverter 300.

The second transformation 640 may be Clarke's Transformation. The second transformation 640 may receive information detected by the current detector 400 and transform the information into current vectors Iα and Iβ.

The third transformation 630 may receive the current vectors transformed by the second transformation 640 and transform them into fixing currents Id and Iq. For example, the third transformation 630 may be Park's Transformation.

The fixing current transformed by the third transformation 630 may be re-input into the PI controller 800, and the motor control device 101 may determine the output state and errors of the motor 200.

The trigonometric function 650 may transform and transmit information detected by the motor location detector 710, which detects the rotation angle of the motor 200 using the third transformation 630 or the first transformation 610.

Hereinafter, the calculation process of the motor reference calculator 100 according to an embodiment of the present disclosure will be described with reference to FIGS. 1 to 10.

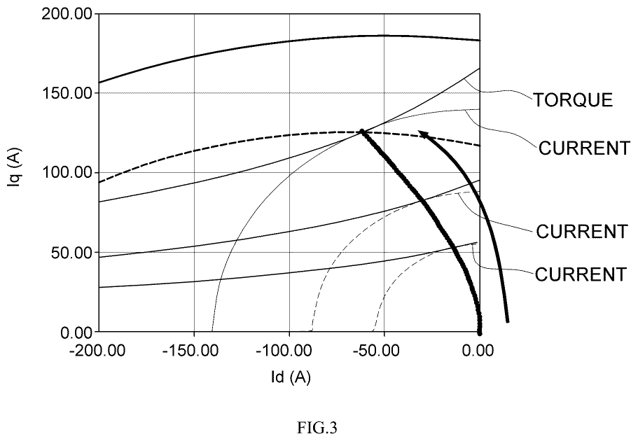

As shown in FIG. 3, the graph of the current is shown in a circular shape. Specifically, the square of the limiting current is expressed as a function of the sum of the square of the d-axis current and the square of the q-axis current.

$${I}_{peak}^{2} = {i}_{d}^{2} + {i}_{q}^{2} \qquad [ Equation 1 ]$$

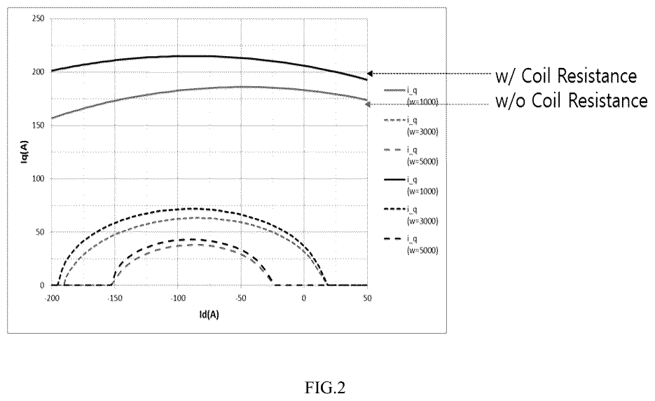

As shown in FIG. 2, the graph of the voltage is shown in an elliptical shape. Specifically, the limiting voltage is expressed as a function of inductance, resistance, motor constant, angular velocity, and d-axis and q-axis currents. The elliptical shape curve in FIG. 2 is the voltage limitation circle.

$${V}_{peak}^{2} = {( {R}_{a} {i}_{d} - ω {L}_{q} {i}_{q} )}^{2} + {( {R}_{a} {i}_{q} + ω {L}_{d} {i}_{d} + {ωΨ}_{a} )}^{2} \qquad [ Equation 2 ]$$

As shown in FIG. 3, the graph of the torque is shown in a curved shape. Specifically, the torque is expressed as a function of output P, motor constant and inductance, and d-axis and q-axis currents. L_{d} and L_{q} represent inductance parameters, Rₐ represents a resistance value, and ψₐ represents a motor constant value.

$$T = \frac{3}{2} \frac{P}{2} \{ {Ψ}_{a} {i}_{q} + ( {L}_{d} - {L}_{q} ) {i}_{d} {i}_{q} \} \qquad [ Equation 3 ]$$

As shown in FIG. 3, the motor reference calculator 100 finds a contact point between the motor torque graph and the current limit graph. Here, L_{d} and L_{q} represent inductance parameters, P represents an output value, and ψₐ represents a motor constant value. The motor reference calculator 100 determines whether the calculated maximum torque exceeds a torque limit (S200). Specifically, limiting torque is a process of chaging the value of torque request from the outside to the maximum torque. The torque limit is the input reference torque value from the final torque signal part 820 or external controller.

When the calculated maximum torque exceeds the torque limit, the motor reference calculator 100 sets this value as the maximum torque per unit current that may be generated by the motor 200 in the current state (S300).

Further, when it is determined that the calculated maximum torque does not exceed a torque limit, the motor reference calculator 100 calculates maximum torque (MTPA) per unit current (S400). Specifically, the motor reference calculator 100 calculates the maximum torque per unit current based on Equation 1 and Equation 3. At this time, the motor reference calculator 100 may calculate the maximum torque per unit current by applying the estimated motor parameters and the previously stored Newton-Raphson method.

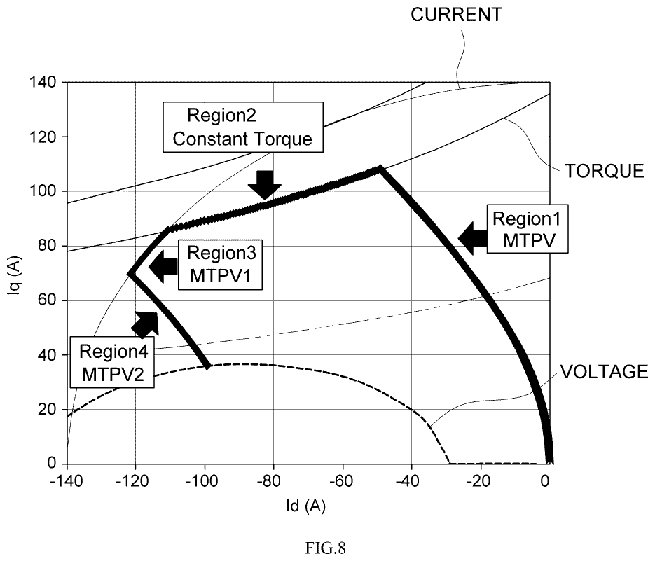

That is, the motor reference calculator 100 may calculate the maximum torque per unit current based on the contact point of Equation 1 and Equation 3. The maximum torque per unit current is shown in FIG. 8 as Region 1 MTPA. Region 1 MTPA represents points where maximum torque may be generated with minimum stator current through the combination of the q-axis and d-axis currents.

Specifically, the motor reference calculator 100 may derive a solution representing the maximum torque per unit current through Equation 1 and Equation 3.

$$9 {{P}^{2} ( {L}_{q} - {L}_{d} )}^{2} {i}_{q}^{4} + 12 TP {Ψ}_{a} {i}_{q} - 16 {T}^{2} = 0$$

In other words, as shown in FIG. 8, Region 1 MTPA represents points within the current limit graph where maximum torque may be generated with minimum stator current through the combination of the q-axis and d-axis currents.

The motor reference calculator 100 determines whether the voltage limit is exceeded (S500). Specifically, the motor reference calculator 100 calculate the voltage limit based on the voltage equation of Equation 2, motor speed, DC link voltage, and estimated motor parameters. Further, the motor reference calculator 100 calculates the voltage with the calculated maximum torque per unit current, and compares it with the calculated voltage limit to determine whether to exceed the voltage limit.

When the value obtained by calculating the voltage with the maximum torque per unit current does not exceed the voltage limit calculated using the voltage equation, the motor reference calculator 100 sets the reference current (S700).

When the value obtained by calculating the voltage with the maximum torque per unit current exceeds the voltage limit calculated using the voltage equation, the motor reference calculator 100 calculates constant torque or maximum torque per unit voltage (S600).

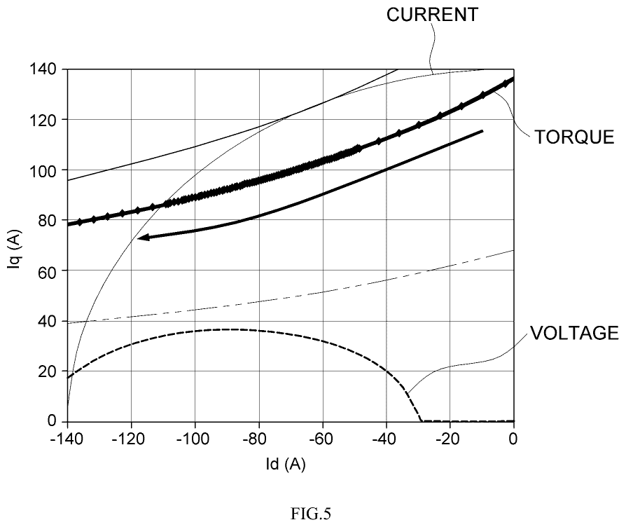

As shown in FIG. 5, the motor reference calculator 100 finds the intersection point of the voltage limit graph and the motor torque graph. The motor reference calculator 100 calculates the constant torque based on Equation 2 and Equation 3 (S610).

$$T = \frac{3}{2} \frac{P}{2} \{ {Ψ}_{a} {i}_{q} + ( {L}_{d} - {L}_{q} ) {i}_{d} {i}_{q} \}$$

$$\to {i}_{d} = \frac{1}{( {L}_{d} - {L}_{q} )} ( \frac{4 T}{3 {Pi}_{q}} - {Ψ}_{a} ) = A ( {Ψ}_{a} - \frac{B}{{i}_{q}} )$$

$$\text{?}$$

$$\text{?} \text{indicates text missing or illegible when filed}$$

As described above, a solution calculated through Equation 2 and Equation 3 is as follows:

$$\text{?}$$

$$\text{?} \text{indicates text missing or illegible when filed}$$

Here, the motor reference calculator 100 may calculate the constant torque by applying the motor speed, the estimated motor parameters, and the pre-stored Newton-Raphson method.

Specifically, FIG. 8 shows Region 2 constant torque where constant torque is maintained. A region in which the calculated constant torque is maintained may be formed. Specifically, the Newton-Raphson method may be used to maintain the continuity of the graph of the constant torque region without omission. Therefore, the stable driving of the motor can be achieved. Further, by forming this constant torque region, the maximum torque of the motor can be effectively used.

The motor reference calculator 100 calculates the voltage limit based on the motor speed, the estimated motor parameter, and the DC link voltage, and calculates the voltage with the calculated constant torque. Further, the motor reference calculator 100 determines whether the voltage calculated with the constant torque exceeds the calculated voltage limit (S620). The elliptical shape in FIG. 2 shows the voltage limiting circle. Specifically, the motor is controlled through an inverter, and the maximum voltage that the inverter can use is limited to the inner area of the elliptical shape in FIG. 2. At this time, the inverter's input is supplied through the dclink capacitor between the battery input and the inverter that controls the motor, to it becomes the same as the dclink voltage. This ellipse is a graph based on the current equation, and the usable area varies depending on the use of the motor and input power, so it is also colled a voltage ellipse.

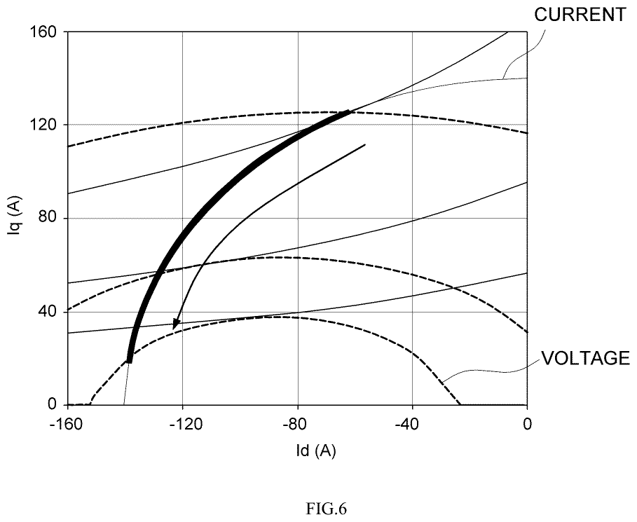

When the voltage limit is exceeded, as shown in FIG. 6, the motor reference calculator 100 finds the intersection point of the current limit graph and the voltage limit graph. The motor reference calculator 100 calculates the maximum torque per unit voltage based on Equation 1 and Equation 2 (S631).

$$\frac{\partial T}{\partial {l}_{d}} \frac{\partial {V}_{peak}^{2}}{\partial {l}_{q}} - \frac{\partial T}{\partial {l}_{q}} \frac{\partial {V}_{peak}^{2}}{\partial {l}_{d}} = 0 , T = \frac{3}{2} \frac{P}{2} \{ {Ψ}_{a} {i}_{q} + ( {L}_{d} - {L}_{q} ) {t}_{d} {i}_{q} \} , {V}_{p}^{2} = {( {R}_{a} {i}_{d} - ω {L}_{q} {i}_{q} )}^{2} + {( {R}_{a} {i}_{q} - ω {L}_{d} {i}_{d} + {ωΨ}_{a} )}^{2}$$

$${( \frac{{V}_{gas}}{\sqrt{3}} )}^{3} = {R}_{a}^{2} {i}_{d}^{2} + {ω}^{2} {L}_{q}^{2} {i}_{q}^{2} - 2 ω {R}_{a} {L}_{q} {i}_{d} {i}_{q} + {R}_{a}^{2} {i}_{q}^{2} + {ω}^{2} {L}_{d}^{2} {i}_{d}^{2} + {ω}^{2} {Ψ}_{a}^{2} + 2 ω {R}_{a} {L}_{d} {i}_{d} {i}_{q} + 2 {ωΨ}_{a} {R}_{a} {i}_{q} + 2 {ω}^{2} {Ψ}_{a} {L}_{d} {i}_{d}$$

$$\frac{\partial {V}_{{peak}^{2}}}{\partial {i}_{q}} = 2 {ω}^{2} {L}_{q}^{2} {i}_{q} - 2 ω {R}_{a} {L}_{q} {i}_{d} + 2 {R}_{a}^{2} {i}_{q} + 2 ω {R}_{a} {L}_{a} {i}_{d} + 2 {ωΨ}_{a} {R}_{a}$$

$$\frac{\partial {V}_{{peak}^{2}}}{\partial {i}_{d}} = 2 {R}_{a}^{2} {i}_{d} - 2 ω {R}_{a} {L}_{q} {i}_{q} + 2 {ω}^{2} {L}_{d}^{2} {i}_{d} + 2 ω {R}_{a} {L}_{a} {i}_{q} + 2 {ω}^{2} {Ψ}_{a} {L}_{d}$$

$$\text{?}$$

$$\text{?}$$

$$\text{?}$$

$$\text{?}$$

$$\text{?}$$

$$\text{?}$$

$$\text{?}$$

$$\text{?}$$

$$\text{?}$$

$$\text{?} \text{indicates text missing or illegible when filed}$$

A solution calculated through Equation 1 and Equation 2 is as follows:

$$4 ( A \text{?} + {C}^{2} ) {i}_{d}^{2} - 6 ( AB + CD ) {i}_{d}^{2} - 2 ( 2 AE - {B}^{2} + {C}^{2} {1}_{p}^{3} - {D}^{2} ) {i}_{d} + 2 ( BE + CD {1}_{p}^{2} ) = 0$$

$$\text{?} \text{indicates text missing or illegible when filed}$$

Specifically, the motor reference calculator 100 may calculate the maximum torque per 10 unit voltage using the preset Regula Falsi method.

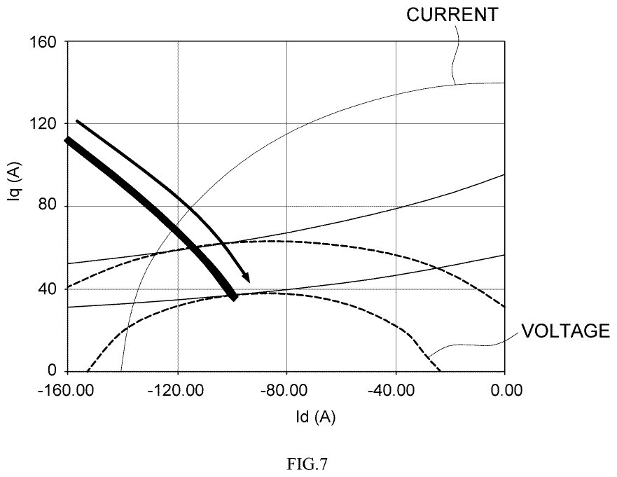

Further, when the voltage limit is exceeded, as shown in FIG. 7, the motor reference calculator 100 finds the contact point between the voltage limit graph and the torque curve.

The motor reference calculator 100 calculates the maximum torque per unit voltage based on Equation 2 and Equation 3 (S630). Specifically, the motor reference calculator 100 may calculate the maximum torque per unit voltage using the preset Regula Falsi method.

$$\text{?}$$

$$\text{?}$$

$$\text{?}$$

$$\text{?}$$

$$\text{?}$$

$$\text{?}$$

$$\text{?} \text{indicates text missing or illegible when filed}$$

A solution calculated through Equation 2 and Equation 3 is as follows:

$$\text{?}$$

$$\text{?} \text{indicates text missing or illegible when filed}$$

Then, the motor reference calculator 100 compares the magnitudes of the maximum torque per unit voltage calculated using different Equations, and sets a larger value as the maximum torque (S640).

As shown in FIG. 8, Region 3 MTPV 1 represents the maximum torque per unit voltage calculated based on Equation 1 and Equation 2.

As shown in FIG. 8, Region 4 MTPV 2 represents the maximum torque per unit voltage calculated based on Equation 2 and Equation 3.

The motor reference calculator 100 sets the reference current to the set maximum torque (S700).

Alternatively, the motor reference calculator 100 sets the reference current when the voltage limit is exceeded (S700).

As shown in FIG. 8, the motor reference calculator 100 may control the motor 200 to be driven at the maximum output torque available in real time, by forming the controllable current region of the permanent magnet synchronous motor 200, which includes a region forming the maximum torque per unit current, a region maintaining the constant torque, and a region forming the maximum torque per unit voltage.

The motor reference calculator converts the torque command into actual usable torque according to the actual driving conditions (motor speed and usable voltage).

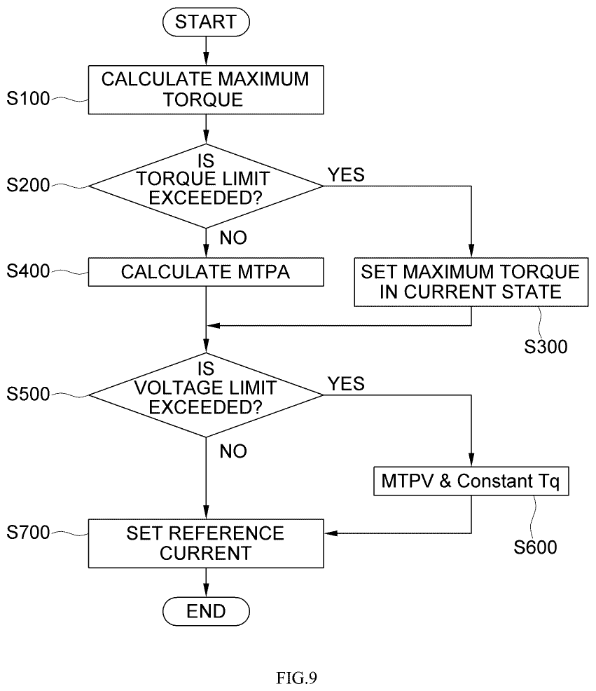

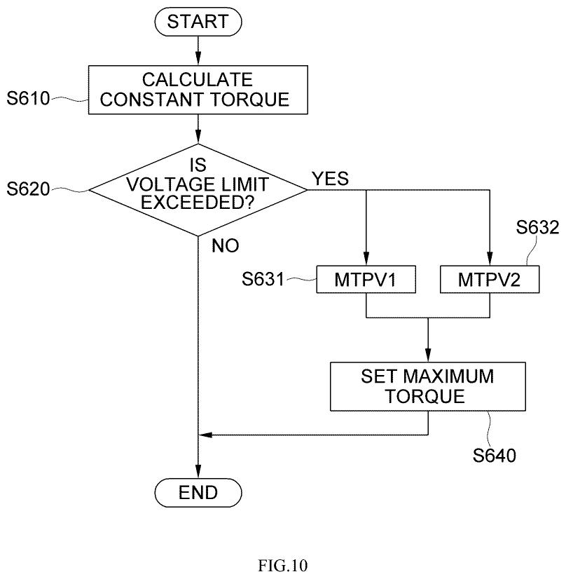

Hereinafter, a motor control method according to an embodiment of the present disclosure will be described with reference to FIGS. 9 and 10.

The maximum torque of the motor is calculated based on the torque command (S100). Based on the received torque command, the maximum torque that may be currently output by the motor 200 is calculated. Specifically, the maximum torque is determined by the maximum value of the current that can be used in the current equation (Equation 1) and the torque equation (Equation 3) to which the motor parameters are applied. The maximum torque can be defined as the torque at the maximum current in the curren equation. In other words, the maximum torque is the torque when Iₚₑₐₖ is the maximum current that can be used.

As shown in FIG. 3., among the current curve according to Equation 1 and the torque curve according to Equation 3, the torque curve placed on the outermost side and in contact with the surface of the current curve using the maximum current is the point of maximu torque. So that the point of contact between these two curves becomes the maximum torque value.

The maximum torque may be the maximum torque value that the motor currently in use produces.

The calculated maximum torque and the torque limit are compared (S200). Specifically, the torque limit is defined as the input reference torque input to the final torque signal part 820.

As shown in FIG. 3, if the torque curve is located outside the current curve, the desired amount of torque cannot be generated even if the current is used to the maximum. The limiting torque refers to the process of modifying the requested external torque value based on the calculated maximum torque in S100. Accordingly, this step can reduce the increase in the number of repetitions and the possibility of finding an incorrect solution in the process of finding a solution by applying the equations described due to an impossible starting value.

For example, in a system where 100 A is the maximum current used, the maximum torque is assumend to be ANm when 100 A inputs the motor. In the final torque signal part 820 or the external controller, the reference torque of BNm(B>A) is input.

At this time, if MTPA or MTPV is perfomed immediately, the value of current(Id, Iq) is repeatedly found using Newton-Raphson method, torque equation, current equation, and voltage equation to convert torque into current.

That is, when the reference torque of BNm(B>A) is found in a range exceeding the maximum torque, there is a problem of finding a problem of the number of repetitions and a wrong solution.

Accodingly, in this step, it may be a process of checkgint the maximum torque and then changing the torque to a range that does not exceed the reference torque. That is, it is a process of changing the reference torque BNm to ANm.

In other words, in this step (S200), the calculated maximum torque is compared with the torque limit to prevent solution errors or an increase in the number of calculations performed due to the numerical analysis starting frome an inpossible starting value. Specifically, when the motor reference calcuatior 100 finds a solution using Newton-Raphson method, if the solution is checked using only voltage and current instead of using the torque equation, there may be a problem where the solution is large than the actual available torque. Therefore, the above-mentioned problem can be solved through this step.

When the calculated maximum torque exceeds the torque limit, the maximum torque per unit voltage that may be generated by the motor in the current state is the torque limit value to be set (S300).

When the calculated maximum torque does not exceed the torque limit, the maximum torque per unit voltage is calculated (S400).

It is determined whether to exceed the voltage limit (S500). Specifically, the voltage is calculated from the calculated maximum torque per unit voltage, and the voltage limit calculated based on the voltage equation is compared by reflecting the estimated motor parameter.

When the voltage limit is exceeded, the constant torque or the maximum torque per unit voltage is calculated (S600).

When the voltage limit is not exceeded, a basal current is set based on the calculated voltage (S700).

As shown in FIG. 10, the constant torque is calculated (S610). Specifically, the constant torque is calculated.

It is determined whether the calculated constant torque exceeds the voltage limit (S620). Specifically, the voltage limit may be calculated by reflecting the estimated motor parameter.

When the voltage limit is exceeded, the maximum torque per unit voltage is calculated (S631, S632).

As described above, the maximum torque per unit voltage includes a step S631 of forming region 3 MTPV1 and a step S632 of forming Region 4 MTPV2.

The maximum torque per each calculated unit voltage is compared and a larger value is set as the maximum torque (S640).

Then, the basal current is set based on the maximum torque that is set in this way (S700).

The control process of the motor control method according to an embodiment of the present disclosure is the same as the calculation process by the motor reference calculator 100 described above.

Therefore, the motor control device 101 and the motor control method according to an embodiment of the present disclosure can control the motor 200 while checking the current available to the motor and the voltage limit, thereby effectively preventing the motor 200 from being out of control or diverging. Further, the motor control device 101 and the motor control method enable the motor 200 to be driven at the maximum output torque under current conditions.

The values calculated by the motor control device 101 for controlling the motor 200 can be used when diagnosing the failure of the motor 200.

Although embodiments of the present disclosure have been described above with reference to the accompanying drawings, those skilled in the art will understand that the present disclosure may be implemented in other specific forms without changing its technical idea or essential features.

Therefore, it should be noted that the above-described embodiments are illustrative in all respects but are not restrictive. The scope of the present disclosure is defined by the claims described below, and all changes or modifications derived from the meaning and scope of the claims and their equivalent concepts should be interpreted as being included in the scope of the present disclosure.

### DETAILED DESCRIPTION OF MAIN ELEMENTS

101: motor control device 100: motor reference calculator
200: motor 820: final torque signal part
500: parameter estimator

What is claimed is:

1. A method of controlling a motor, the method comprising:
receiving a torque command for controlling the motor;
calculating maximum torque of the motor based on the torque command;
determining whether the calculated maximum torque exceeds a torque limit; and
in response to determination that the calculated maximum torque does not exceed the torque limit, calculating maximum torque per unit current to control the motor.

2. The method of claim 1, wherein the maximum torque per unit current is calculated based on input reference torque and an estimated motor parameter.

3. The method of claim 2, wherein the motor parameter is estimated based on a temperature of the motor.

4. The method of claim 1, further comprising:
calculating voltage using the calculated maximum torque per unit current to determine whether the calculated voltage using the calculated maximum torque per unit current exceeds a voltage limit.

5. The method of claim 4, further comprising:
in response to determination that the calculated voltage using the calculated maximum torque per unit current exceeds the voltage limit, calculating constant torque or maximum torque per unit voltage.

6. The method of claim 5, wherein the calculating of the constant torque or the maximum torque per unit voltage comprises:
calculating the constant torque based on a motor speed and an estimated motor parameter; and
determining whether an other voltage calculated using the calculated constant torque exceeds the voltage limit.

7. The method of claim 6, wherein the calculating of the constant torque or the maximum torque per unit voltage further comprises:
calculating the maximum torque per unit voltage based on a current equation or a torque equation, when the other voltage calculated using the calculated constant torque exceeds the voltage limit.

8. The method of claim 7, wherein the calculating of the constant torque or the maximum torque per unit voltage further comprises:
comparing the maximum torque per unit voltage calculated based on the current equation and the maximum torque per unit voltage calculated based on the torque equation; and
setting a larger torque among the maximum torque per unit voltage calculated based on the current equation and the maximum torque per unit voltage calculated based on the torque equation as the maximum torque.

9. The method of claim 8, further comprising:
setting a reference current based on the set maximum torque.

10. The method of claim 1, wherein the maximum torque per unit current is calculated using a contact point where a current limit curve and a torque curve meet.

11. The method of claim 6, wherein the constant torque is calculated using an intersection point where a voltage limit curve and the torque curve intersect.

12. The method of claim 7, wherein the maximum torque per unit voltage is calculated using an intersection point where the current limit curve and the voltage limit curve intersect.

13. The method of claim 7, wherein the maximum torque per unit voltage is calculated using a contact point where the voltage limit curve and the torque curve meet.

14. A device for controlling a motor, the device comprising:
one or more processors; and
memory configured to store instructions that, when executed by the one or more processors, cause the one or more processors to perform operations comprising:
generating a torque command for controlling the motor and reference torque;
estimating motor parameter information based on a temperature of the motor; and
outputting q-axis and d-axis reference currents according to the torque command and the motor parameter information to control the motor.

15. The device of claim 14, wherein the one or more processors are configured to output the q-axis and d-axis reference currents using a Newton-Raphson method and a Regula Falsi method.

16. The device of claim 14, wherein the one or more processors are configured to calculate a maximum torque per unit voltage using a Regula Falsi method.

17. The device of claim 14, wherein theone or more processors are configured to form a controllable current region including a region that forms a maximum torque per unit current, a region that maintains a constant torque, and a region that forms a maximum torque per unit voltage.
